(19) United States
(12) Patent Application Publication
(10) Pub. No.: US 2018/0354585 A1
(43) Pub. Date: Dec. 13, 2018

(54) BICYCLE CRANKSET WITH ECCENTRIC CHAINRING AND ADJUSTABLE CRANKARM

(71) Applicant: DRIVETRAIN TECH SOLUTION INC., Taichung (TW)

(72) Inventor: PO-CHENG CHEN, Taichung (TW)

(73) Assignee: DRIVETRAIN TECH SOLUTION INC.

(21) Appl. No.: 15/616,468

(22) Filed: Jun. 7, 2017

(51) Int. Cl. B62M 9/08; B62M 1/36; F16H 35/00; F16H 55/30

(52) U.S. Cl. CPC B62M 9/085; B62M 1/36; B62M 2009/002; F16H 55/30; F16H 35/00

(57) ABSTRACT

A bicycle crankset includes a chainring, a spider, and a crankarm. The chainring has a disk member and a plurality of teeth on an edge of the disk member to engage a chain. The spider is connected to the disk member of the chainring, and has a connecting bore and a plurality of recesses on an edge of the connecting bore. The crankarm has a plurality of protrusions to engage the recesses of the spider. The connecting bore is eccentric relative to the chainring, and the crankarm is able to be connected to the chainring in different angles by engaging the protrusions of the crankarm with different of the recesses of the spider to provide various paths of motion of the chainring.

### BACKGROUND OF THE INVENTION

### 1. Technical Field

The present invention relates to a bicycle, and more particularly to a bicycle crankset with an eccentric chainring and an adjustable crankarm.

### 2. Description of Related Art

Typically, a bicycle is provided with a round chainring and a pair of crankarms connected to the chainring through a spider. A rider steps pedals of the crankarms to turn the chainring, so as to drive the bicycle forward. However, a motion of the crankarms is round, and a motion of feet of the rider is up and down. Therefore, lots of the power transmitted from rider's feet to the crankarms is lost.

When a rider is stepping the crankarms, the power is positive when the rider steps the crankarms downward, and the power is maximum when the crankarm is moved to a horizontal position. After the lowest position, the power is negative which does not help the bicycle move.

The modern bicycle provides an elliptical chainring to solve this problem. Taiwan patent no. 1399322 disclosed a bicycle chainring with different radiuses. This chainring provides different arms of force according to the position of the crankarm to improve the efficiency of stepping the crankarms.

U.S. Pat. No. 7,749,117 disclosed an elliptical chainring. The chainring is adjustable according to its position and shape to meet various needs of different riders. This patent also provides the chainring with the parameters the same as a normal chainring at the region when the rider is stepping downward to reduce the loading of knees.

### BRIEF SUMMARY OF THE INVENTION

In view of the above, the primary objective of the present invention is to provide a bicycle crankset, which is adjustable for its motion to obtain high torque output and high power efficiency.

In order to achieve the objective of the present invention, a bicycle crankset includes a chainring, a spider, and a crankarm. The chainring has a disk member and a plurality of teeth on an edge of the disk member to engage a chain. The spider is connected to the disk member of the chainring, and has a connecting bore and a plurality of recesses on an edge of the connecting bore. The crankarm has a plurality of protrusions to engage the recesses of the spider. The connecting bore is eccentric relative to the chainring, and the crankarm is able to be connected to the chainring in different angles by engaging the protrusions of the crankarm with different of the recesses of the spider to provide various paths of motion of the chainring.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is a front view of the chainring and the spider of the preferred embodiment of the present invention;

FIG. 3 is a front view of the preferred embodiment of the present invention;

FIG. 4 is another front view of the preferred embodiment of the present invention;

FIG. 5 is a front view of the preferred embodiment of the present invention, showing the motion of the chainring and the crankarm;

FIG. 6 and FIG. 7 are front views of the preferred embodiment of the present invention, showing the crankarms mounted in different angles;

FIG. 7 is a sketch view of the preferred embodiment of the present invention, showing the different paths of motion;

FIG. 8 is a front view of another preferred embodiment of the present invention, showing the elliptical chainring; and

FIG. 9 is a front view of yet another preferred embodiment of the present invention, showing an alternate spider.

### DETAILED DESCRIPTION OF THE INVENTION

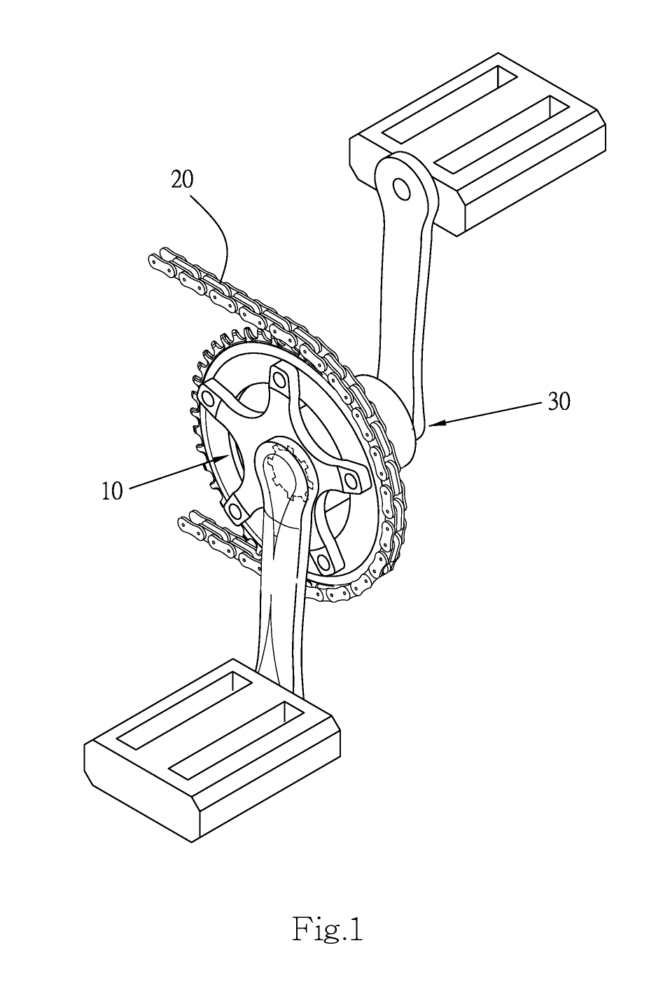

FIG. 1 shows a bicycle crankset of the preferred embodiment of the present invention, including a chainring 10, a chain 20 engaging the chainring 10, and a pair of crankarms 30 connected to the chainring 10 to turn the chainring 10 by stepping the carnkarms 30.

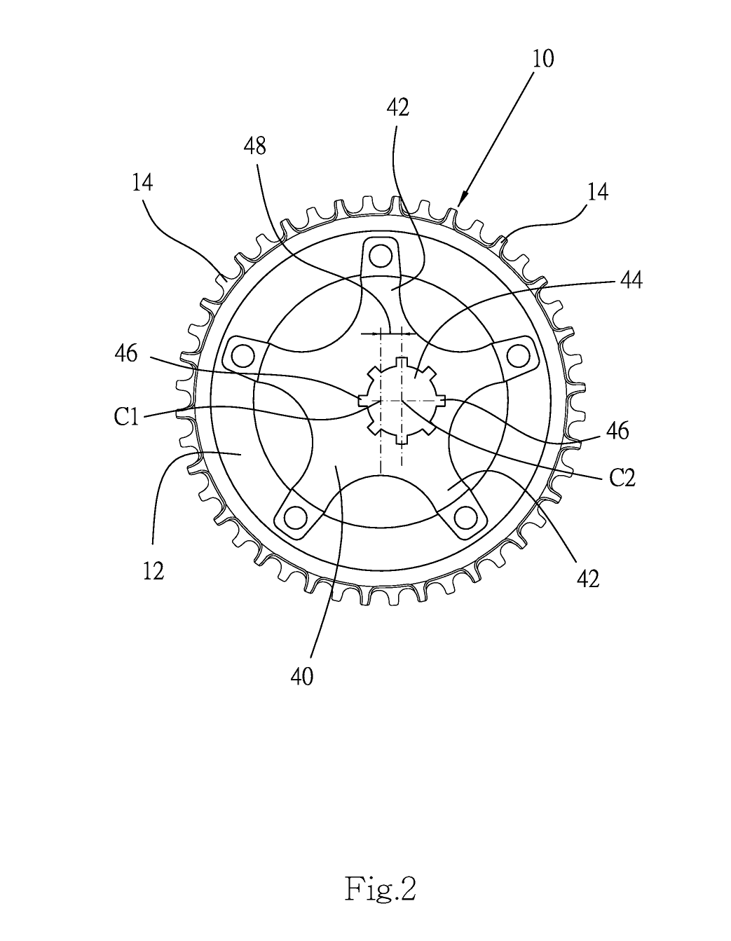

As shown in FIG. 2, the chainring 10 has a disk member 12, a plurality of teeth 14 on an edge of the disk member 12. The teeth 14 are in a round circumference. A spider 40 is connected to the disk member 12 of the chainring 10. The spider 40 has a plurality of connecting arms 42 to be connected to the disk member 12 by bolts or other fasteners. In another embodiment, the spider 40 is directly formed on the disk member 12 (not shown).

The spider 40 has a connecting bore 44 and a plurality of recesses 46 on an edge of the connecting bore 44. The connecting bore 44 is not at a center of the spider 40, in other words, the connecting bore 44 is eccentric, so that an eccentric distance 48 is formed between a center C1 of the chainring 10 and a center C2 of the connecting bore 44.

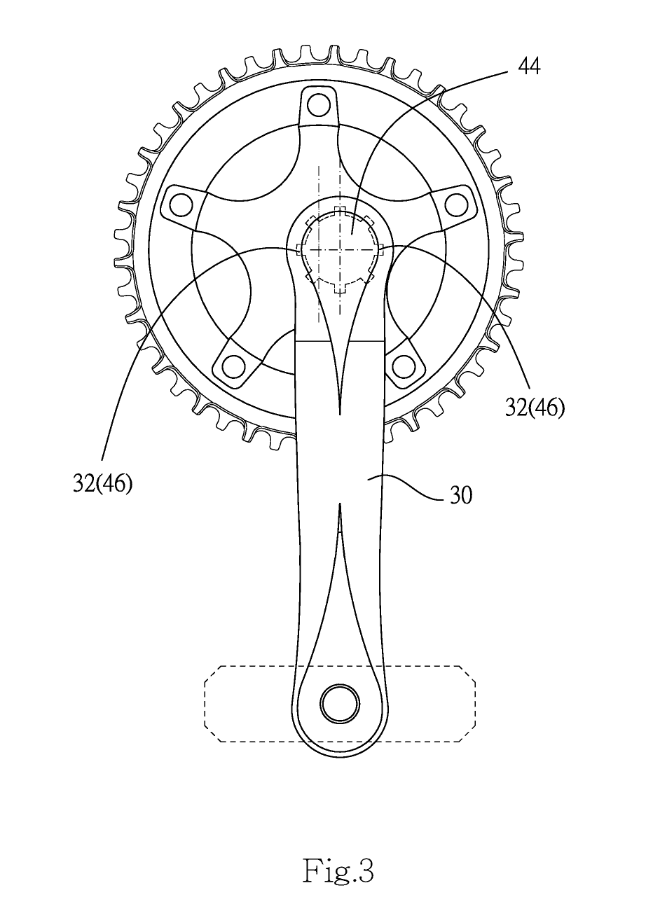

As shown in FIG. 3, one of the crankarm 30 has a plurality of protrusions 32 on an end thereof to engage the recesses 46 of the spider 40. In the present embodiment, the arrangement of the recesses 46 is regular, in other words, there are constant intervals between each two of the neighboring recesses 46, and the recesses 46 are arranged in a round circumference, while the arrangement of the protrusions 32 are complementary to the recesses 46. In another embodiment, the arrangement of the recesses 46 is irregular, and the protrusions 32 are complementary to the recesses 46.

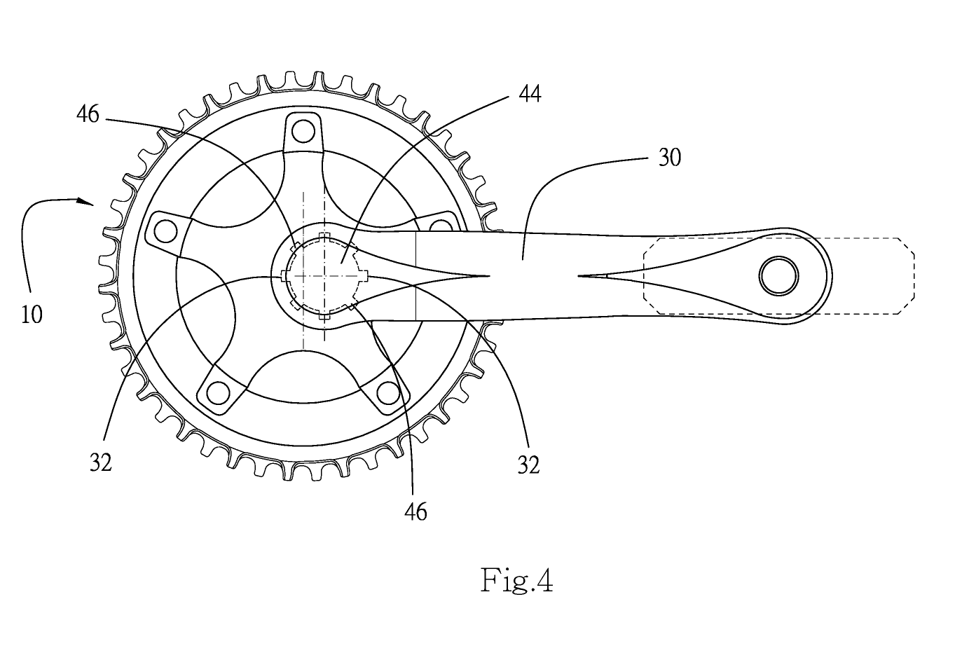

As shown FIG. 4, since the arrangements of the recesses 46 and the protrusions 32 are regular, the crankarm 30 may be connected to the spider 40 in different angles.

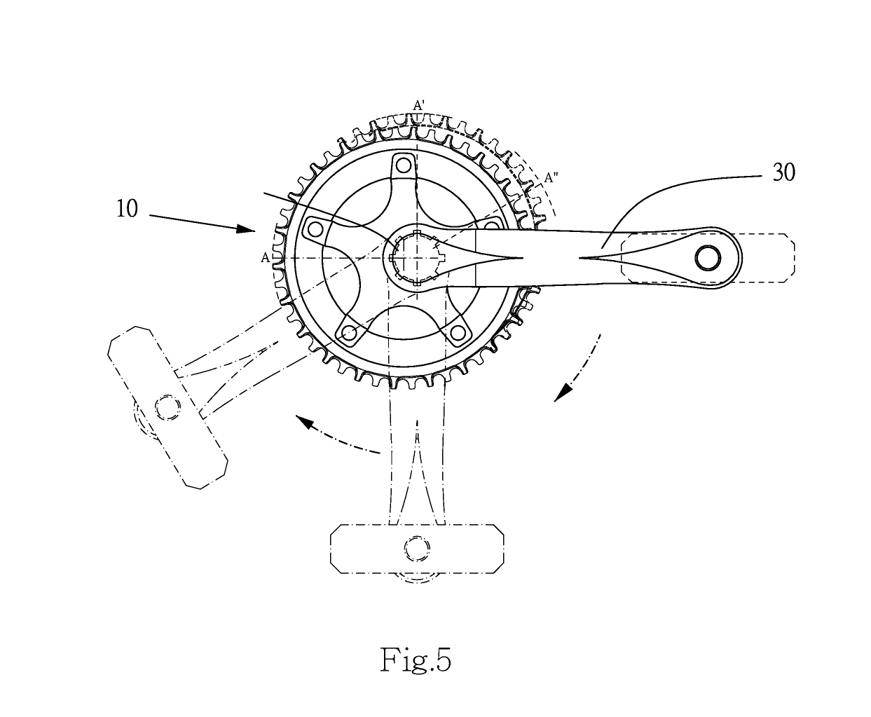

As shown in FIG. 5, since the crankarm 30 is eccentric, a motion of the chainring 10 is not round, and it may approach a motion of an elliptical chainring. Comparison to the motion of the elliptical chainring, a change of a curvature radius of a path of the motion of the chainring 10 of the present embodiment is smoother to provide a stable loading to the rider when he/she is stepping the crankarms 30 and a high efficiency of power transmission.

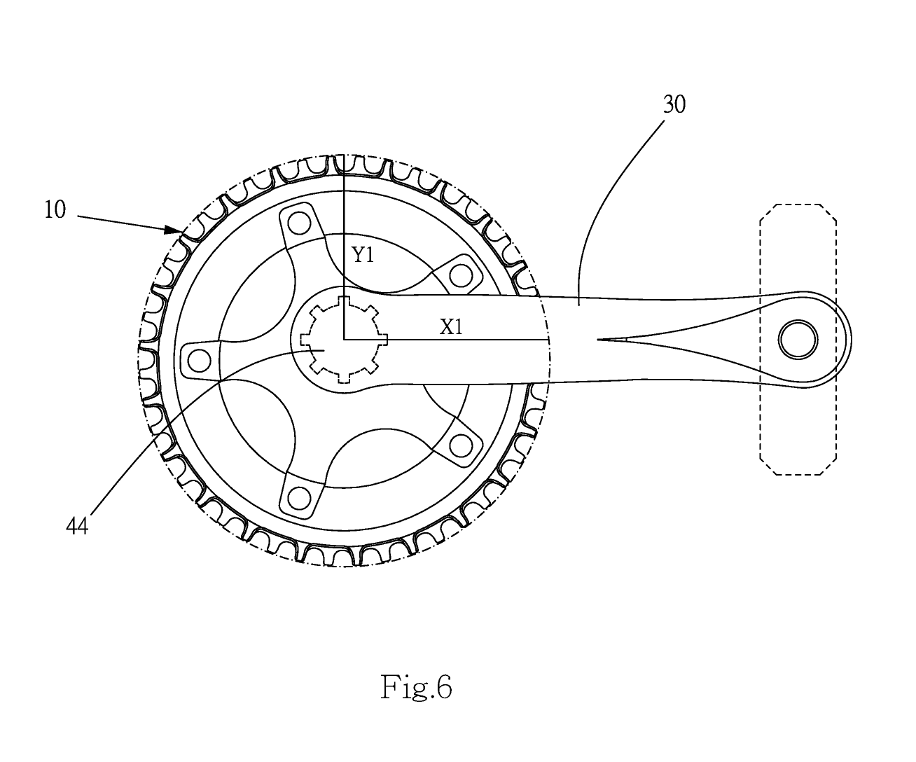

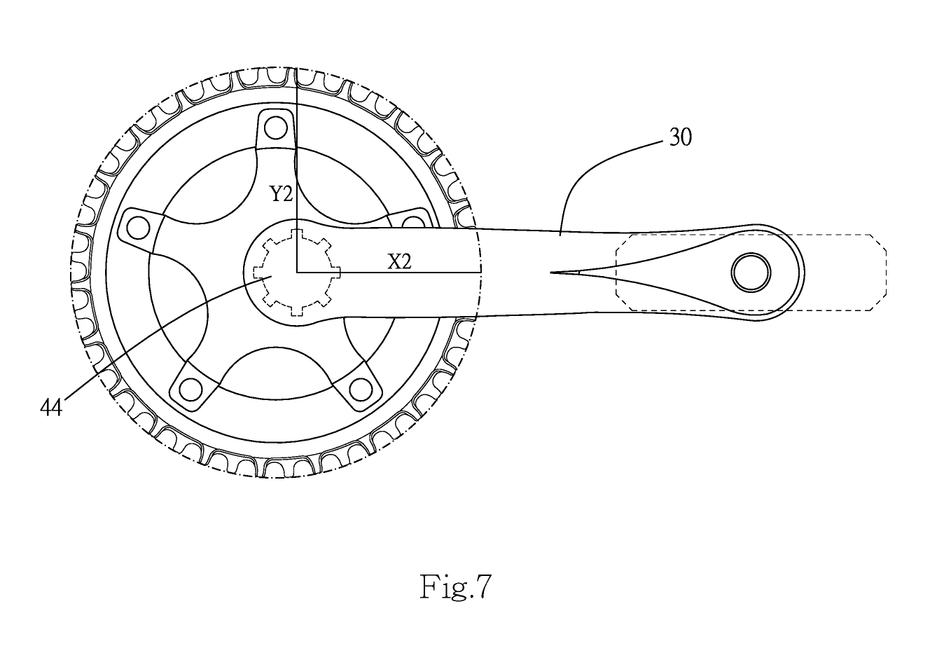

As shown in FIG. 6 and FIG. 7, when the crankarm 30 is connected to the spider 40 in different angles, distances between a center of the connecting bore 44 and tips of the teeth 14 at the same orientations will be different (comparing X1 of FIG. 6 to X2 of FIGS. 7, and Y1 of FIG.6 to Y2 of FIG. 7). As a result, a path of motion of the chainring 10 of FIG. 6 is different from that of the chainring 10 of FIG. 7. In other words, the path of motion of the chainring 10 is changeable by connecting the crankarm 30 to the chainring 10 in different angles.

In conclusion, the present embodiment provides the path of motion of the chainring 10 with a smooth change of the curvature radius thereof (FIG. 5), and the path of motion of the chainring 10 is changeable (FIG. 6 and FIG. 7) to provide an efficient power output when cycling on different roads.

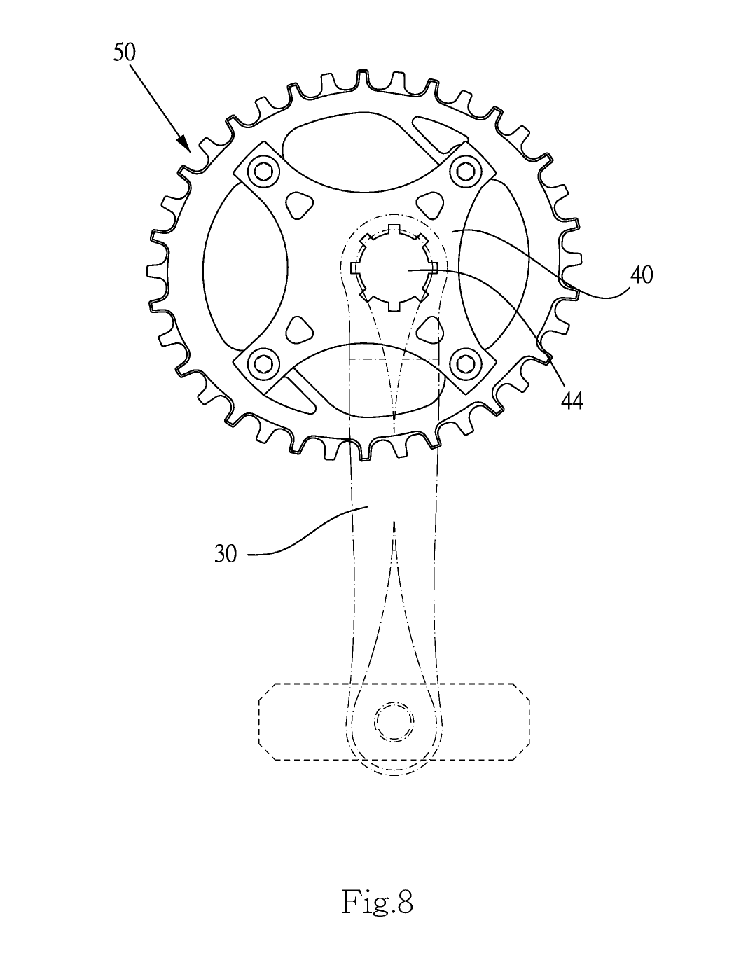

As shown in FIG. 8, another embodiment of the present invention provides an elliptical chainring 50, and the crankarm 30 is eccentrically connected to the chainring 50 through the spider 30. The same as above, the crankarm 30 may be connected to the chainring 50 in different angle, so that the path of motion of the chainring 50 is changeable as well.

The elliptical chainring 50 provides a noncircular path of motion while the eccentric crankarm 30 provides another changeable noncircular path of motion. The combination of the elliptical chainring 50 and the eccentric crankarm 30 provides various paths of motion of the chainring 50.

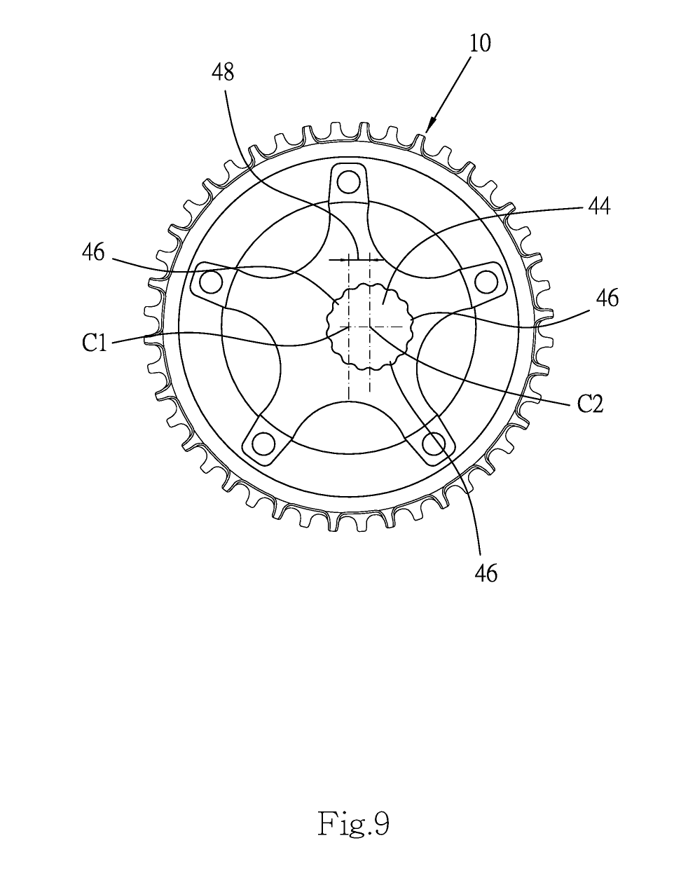

As shown in FIG. 9, yet another embodiment of the present invention provides the chainring 10 with an eccentric connecting bore 44, which has an eccentric distance 48 between the center C1 of the chainring 10 and the center C2 of the connecting bore 44. The connecting bore 44 has a weave-like edge to form the recesses 46, so that the crankarm 30 is able to be connected to the chainring 10 in different angle.

It must be pointed out that the embodiments described above are only some preferred embodiments of the present invention. All equivalent structures which employ the concepts disclosed in this specification and the appended claims should fall within the scope of the present invention.

1. A bicycle crankset, which is adapted to connect to a chain, comprising:
a chainring having a disk member and a plurality of teeth on an edge of the disk member to engage the chain;
a spider, which is connected to the disk member of the chainring, having a connecting bore and a plurality of recesses on an edge of the connecting bore; and
a crankarm having a plurality of protrusions, wherein the crankarm is connected to the spider by engaging the protrusions with the recesses of the spider;
wherein a center of the connecting bore is not on a center of the disk member of the chainring, and the crankarm is able to be connected to the chainring in different angles by engaging the protrusions of the crankarm with different of the recesses of the spider to provide various paths of motion of the chainring;
wherein the spider is fixedly connected to the disk member of the chainring, and the connecting bore is kept at a fixed position relative to the chainring when the crankarm is turned, so that the chainring is turned in a not round path of motion.

2. The bicycle crankset of claim 1, wherein the teeth of the chainring are in an elliptical circumference.

3. The bicycle crankset of claim 1, wherein the teeth of the chainring are in a round circumference.

4. The bicycle crankset of claim 1, wherein the spider has a plurality of connecting arms to be connected to the disk member of the chainring.

5. (canceled)
